(19) United States
(12) Patent Application Publication
(10) Pub. No.: US 2026/0116028 A1
(43) Pub. Date: Apr. 30, 2026

(54) Leaf-inspired hydrogel composite and preparation method Thereof

(71) Applicant: Jiangnan University, Wuxi (CN)

(72) Inventors: Shaohai FU, Wuxi (CN); Diandian ZHANG, Wuxi (CN); Wen ZHOU, Wuxi (CN)

(21) Appl. No.: 19/258,912

(22) Filed: Jul. 3, 2025

Related U.S. Application Data
(63) Continuation of application No. PCT/CN2025/090033, filed on Apr. 21, 2025.

(30) Foreign Application Priority Data
Oct. 25, 2024 (CN) 2024115029487

(51) Int. Cl. B29D 7/00; B29K 29/00; B29K 105/00; B29K 105/24; C09D 4/06; C09D 129/04; D06P 1/16; D06P 1/673; D06P 3/54; D06P 3/60

(52) U.S. Cl. CPC B29D 7/00; C09D 4/06; C09D 129/04; D06P 1/16; D06P 1/673; B29K 2029/04; B29K 2105/0002; B29K 2105/0032; B29K 2105/0061; B29K 2105/24; D06P 3/54; D06P 3/6033

(57) ABSTRACT

Disclosed are a leaf-inspired hydrogel composite and a preparation method thereof, belonging to the field of biomimetic composites. The disclosure includes the following steps: preparing a green fabric by formulating a printing paste with a colorant and printing it onto a fabric, thereby obtaining the green fabric capable of simulating the “green peak” and “red edge” spectral features of plant leaves, mimicking the palisade tissue and skeletal structure of leaves using the green fabric; formulating a hydrogel prepolymer solution using PVA as a matrix, combined with a highly hygroscopic monomer, a crosslinking agent, and an initiator; and finally pouring the solution into a mold containing the green fabric for polymerizing, enabling in situ hydrogel formation on the fabric surface and within its pores to yield the leaf-inspired hydrogel composite. The composite eliminates reliance on hygroscopic salts while ensuring stable moisture absorption and simulation performance, as well as excellent durability.

### TECHNICAL FIELD

The present disclosure relates to a leaf-inspired hydrogel composite and a preparation method thereof, belonging to the field of biomimetic composites.

### BACKGROUND

Plant leaves, as vital botanical components, have become quintessential biomimetic prototypes due to their multifunctional structures and survival properties. At present, leaf-inspired biomimetic structures and materials find extensive applications in various fields such as materials science, medicine, sensors, mechanics, and optics. Despite botanical diversity of plant leaves, their reflectance spectra universally exhibit four distinct spectral features within the range of 400-2,500 nm: the “green peak,” “red edge,” “near-infrared plateau”, and “water absorption valleys”.

At present, the “green peak,” “red edge,” and “near-infrared plateau” of plant leaves can be effectively simulated through the combination of colorants and the regulation of material structures. However, the simulation of the “water absorption valleys” remains challenging. The formation of the “water absorption valleys” spectral feature is predominantly attributed to the water content in plant leaves. In existing research, there are three main approaches to imparting materials with the “water absorption valleys”: mechanical water addition, encapsulated water, and self-driven water absorption. Among them, self-driven water-absorbing materials that mimic plant transpiration through environmental humidity-responsive water absorption have emerged as a research focus. Nevertheless, existing self-driven water-absorbing leaf-inspired materials (e.g., CN114214847A), typically employ highly hygroscopic metal salts to absorb moisture from the air, thereby simulating the “water absorption valleys”. However, the hygroscopic salts in these materials often exhibit leakage during application, leading to unstable moisture absorption, degraded simulation performance, poor durability. Meanwhile, the structures of these materials are complex, and their internal bonding fastness is relatively poor.

### SUMMARY

### Technical Problem

The existing self-driven water-absorbing leaf-inspired materials utilizing hygroscopic salts often exhibit hygroscopic salt leakage during application, leading to unstable moisture absorption, degraded simulation performance of the “water absorption valleys”, poor durability. Meanwhile, the structures of these materials are complex, and their internal bonding fastness is relatively poor.

### Technical Solution

To address the above issues, the present disclosure provides a leaf-inspired hydrogel composite and a preparation method thereof, which eliminates reliance on hygroscopic salts while ensuring stable moisture absorption and simulation performance, as well as excellent durability. The present disclosure includes the following steps: preparing a green fabric by formulating a printing paste with a colorant and printing it onto a fabric, thereby obtaining the green fabric capable of simulating the “green peak” and “red edge” spectral features of plant leaves, mimicking the palisade tissue and skeletal structure of leaves using the green fabric; formulating a hydrogel prepolymer solution using a biological material polyvinyl alcohol (PVA) as a matrix, combined with a highly hygroscopic monomer, a crosslinking agent, and an initiator; and finally pouring the hydrogel prepolymer solution into a mold containing the green fabric for polymerizing, enabling in situ hydrogel formation on the fabric surface and within its pores to yield the leaf-inspired hydrogel composite. The resulting biomimetic composite of the present disclosure replicates all the spectral features of plant leaves across 400-2,500 nm while structurally resembling leaf morphology. Meanwhile, the highly hygroscopic hydrogel in the composite autonomously regulates water absorption/release via environmental humidity, mimicking plant transpiration without hygroscopic salt leakage risks. Additionally, the hydrogel exhibits robust adhesion to the fabric substrate through strong hydrogen bonding, ensuring excellent bonding strength with the internal fabric.

A first objective of the present disclosure is to provide a method for preparing a leaf-inspired hydrogel composite, which includes the following steps:
(1) preparation of green fabric:
uniformly mixing a colorant, printing auxiliaries, and water to form a paste-like green
printing paste; subsequently applying the printing paste onto a fabric surface via screen printing to obtain a green fabric;
(2) preparation of hydrogel prepolymer solution:
mixing PVA, a highly hygroscopic monomer, a crosslinking agent, an initiator, and water and stirring uniformly to obtain a hydrogel prepolymer solution; and
(3) preparation of leaf-inspired hydrogel composite:
combining the green fabric obtained in step (1) with the hydrogel prepolymer solution obtained in step (2), followed by thermal polymerization to yield the leaf-inspired hydrogel composite.

In one embodiment of the present disclosure, the colorant in step (1) includes one or more selected from chromium oxide, a disperse dye, a vat dyes, an acid dye, a reactive dye, dry leaf powder, and sodium copper chlorophyllin.

In one embodiment of the present disclosure, the screen printing in step (1) includes various types such as flat screen printing and rotary screen printing. Flat screen printing involves stretching a screen onto a rectangular frame to form a planar screen plate. The printing paste is transferred to a substrate through the graphic part of the screen plate by the pressure of a squeegee, thereby achieving printing.

In one embodiment of the present disclosure, the printing auxiliaries in step (1) include one or more selected from a dispersant, a thickener, and an adhesive.

In one embodiment of the present disclosure, the dispersant includes one or more selected from Reax 85A, AD-4600, 5080W, NNO, DM 1501, DM 1501N, PVP, and BYK-190. Among them,

dispersant Reax 85A primarily consists of low-sulfonated sodium lignosulfonate. Reax 85A has a moderate molecular weight, is an excellent anionic surfactant, and can be used as a filler and dispersant for reduction and disperse dyes, and as a diluent for acid dyes.

AD-4600 is a polymer aqueous solution containing pigment-affinitive groups, synthesized via controlled polymerization technology, with optimal control of molecular weight and distribution. The AD-4600 has good compatibility: which is suitable for aqueous-based systems and various resin types of inks and coatings. The AD-4600 is suitable for grinding, dispersing and stabilizing carbon black, phthalocyanine blue, organic pigments, and inorganic particles. The AD-4600 enhances grinding efficiency, fluidity, tinting strength, and transparency, and exhibits excellent long-term stability.

The chemical composition of 5080W is a combination of sodium polyacrylate and fatty alcohol phosphate ester, with an active content of (30±2) % and a transparent, colorless liquid appearance. Sodium polyacrylate is a high-molecular-weight electrolyte exhibiting excellent water solubility and dispersion capabilities. It maintains particle dispersion via electrostatic repulsion and steric hindrance effect. Fatty alcohol phosphate ester has surfactant properties, and can reduce liquid-liquid and solid-liquid interfacial tension, better aid in particle wetting by a medium and improve dispersion efficacy. The combination of these two components enables dispersant 5080W with excellent dispersion properties in various systems, making it widely used in coatings, inks, ceramics, and other fields.

Dispersant NNO, chemically known as sodium methylene dinaphthalene sulfonate (alternatively termed as naphthalene sulfonate formaldehyde condensate), has the molecular formula C₂₁H₁₄O₆S₂Na₂.

Dispersant DM 1501 contains aromatic ester compounds and sulfonate surfactants as effective constituents. By weight, aromatic ester compounds account for 60-80%, and sulfonate surfactants account for 20-40%. In the textile printing and dyeing industry, it can be used for promoting the dissolution and dispersion of reactive dyes, preventing dye aggregation caused by direct contact between high-concentration salt-alkali mixtures and dyes, and avoiding salt-induced precipitation of reactive dyes in reclaimed water. It also plays a dispersing role in the removal of color and oil stains during the fixation process of cotton and chinlon fabrics.

DM 1501N, an anionic multifunctional dispersant, can be suitable for dispersing various dyes, especially for turquoise series such as reactive, direct, and disperse dyes. It effectively prevents the formation of color spots and stains and exhibits strong anti-sedimentation dispersing capabilities, and can prevent the precipitation of dyes during co-bathing dyeing of different ionic dyes.

PVP refers to polyvinyl pyrrolidone.

BYK-190 is a wetting dispersant for aqueous systems. Chemical composition: A high-molecular-weight block copolymer solution containing pigment-affinitive groups, with water as the solvent and an active constituent content of typically 40%. Product characteristics: Acid value of 10 mg KOH/g and a density of 1.06 g/mL at 20° C. Primary applications: It is used in aqueous coating systems, printing inks, and adhesives, particularly for applications requiring improved pigment dispersion and reduced viscosity. It enhances pigment wetting and gloss, and reduces grinding viscosity.

In one embodiment of the present disclosure, the thickener includes one or more selected from TF-3181SS, TF-313E, TF-313B, TF-312NW, DM-5221G, DM-5228, DM-5298, and sodium alginate.

Among them,

TF-3181SS is an anionic printing paste primarily used for thickening in cotton and polyester printing systems. It can be used alone and offers higher color yield and more vibrant colors compared to sodium alginate. It provides clear print contours, suitable for printing halftone dot and fine-line patterns. Dosage: 3-6%.

TF-313E is an anionic thickener primarily used for pigment printing of cotton and polyester fabrics and disperse printing of polyester fabrics. It thickens rapidly, producing clear patterns with high color yield. Dosage: 1.8-3%.

TF-313B is an anionic thickener primarily used for thickening in pigment printing and other aqueous systems. It offers excellent thickening capabilities, rapid thickening, stable color paste, and clear print contours. Dosage: 2.5-3%.

TF-312NW is an anionic, environment-friendly thickener primarily used for thickening waterless disperse printing color pastes for polyester fibers and other aqueous systems. It allows for waterless disperse printing, resulting in soft and natural hand feel, excellent thickening capabilities, good color yield, and environmental friendliness. Dosage: 0.5-2.0%.

DM-5221G is an anionic dispersing thickener primarily used for thickening disperse printing color pastes of polyester fabrics. Appearance: Light yellow or white viscous emulsion. Dosage: 3-5%.

DM-5228 is an anionic printing thickener primarily used for thickening pigment printing color pastes of pure cotton/cotton-polyester and pure polyester fabrics. Appearance: Milky white viscous liquid. Usage and dosage: 1.5-2.0% for printing, high strength, low usage, and rapid thickening rate.

DM-5298 is an anionic thickener primarily used for thickening disperse printing color pastes of polyester fabrics. Appearance: Light yellow viscous emulsion. Dosage: 2-5%.

In one embodiment of the present disclosure, the adhesive includes one or more selected from TF-3211, TF-321A, TF-3201 YD, TF-3201R, TEP, BST-N788, DM 5128A, and DM 5120.

The adhesive TF-3211 is an anionic pigment printing adhesive used for flat screen and rotary screen printing, and also as a nonwoven fabric adhesive. It offers good formulation compatibility and a soft hand feel. It provides excellent rub and brush fastness. Dosage: 5-25%.

TF-321A is an anionic adhesive used for flat screen and rotary screen pigment printing, and also as a nonwoven fabric adhesive. It offers good formulation compatibility, vibrant colors, and high color yield. It provides excellent rub and brush fastness. Dosage: 5-25%.

TF-3201 YD is an anionic adhesive used for flat screen and rotary screen pigment printing, and also as a nonwoven fabric adhesive. It offers good formulation compatibility, vibrant colors, and high color yield. It provides excellent rub, wash, and brush fastness, a soft hand feel, and prevents clogging of screens during printing. It is environmentally friendly and suitable for infant clothing processing. Dosage: 5-25%.

TF-3201R is an anionic adhesive used for flat screen and rotary screen pigment printing, and also as a nonwoven fabric adhesive. It offers good formulation compatibility, vibrant colors, and high color yield. It provides excellent rub, wash, and brush fastness, a soft hand feel, and prevents clogging of screens during printing. Dosage: 5-25%.

TEP is a super-soft, environment-friendly adhesive widely used in pigment printing and pigment dyeing. Appearance: Milky white emulsion. Composition: Block copolymer of acrylic resin and specialty polymers. pH value: 6.0-7.5. Ionicity: Anionic/nonionic. Solid content: 35%.

BST-N788 is a super-soft adhesive. Appearance: Milky white fluid liquid with a blue tinge. Composition: It is composed of acrylic self-crosslinking monomers and modified organosilicon. Solid content: 35%. pH value: 7.0-7.5. Ionicity: Nonionic.

DM 5128A is an anionic formaldehyde-free adhesive, appearing as a milky white or light yellow viscous liquid. It is primarily used for reactive-effect pigment printing of various pure cotton or polyester-cotton fabrics. The resulting fabric is smooth, soft, and non-sticky, with good dry and wet rub fastness and brush fastness. Dosage: 3-20%.

DM 5120 is an anionic adhesive which can be used for reactive-effect pigment printing of various types of pure cotton or polyester-cotton fabrics. Appearance: Milky white liquid. Usage and dosage: 5-25% for printing.

In one embodiment of the present disclosure, the green printing paste in step (1) is prepared by uniformly mixing and stirring the colorant, the printing auxiliaries and water into a paste, wherein, the colorant is present in an amount of 0.1-5.0 wt % in the green printing paste, and the printing auxiliaries are present in an amount of 5-40.0 wt % in the green printing paste.

In one embodiment of the present disclosure, the fabric in step (1) includes one or more selected from a polyester fabric, a polyester-cotton blended fabric, a cotton fabric, a viscose fabric, and a chinlon fabric.

In one embodiment of the present disclosure, the PVA in step (2) includes one or more types selected from polyvinyl alcohol 1788, low-viscosity polyvinyl alcohol 1788, polyvinyl alcohol 1799, polyvinyl alcohol 1792, polyvinyl alcohol 0588, polyvinyl alcohol 0599, polyvinyl alcohol 1750±50, and polyvinyl alcohol 124.

Among them, polyvinyl alcohol 1788 refers to a polyvinyl alcohol product with a degree of polymerization of around 1,700 and a degree of alcoholysis of around 88%.

Low-viscosity polyvinyl alcohol 1788 refers to a low-viscosity polyvinyl alcohol with a degree of polymerization of around 1,700 and a degree of alcoholysis of around 88%, with a viscosity typically in the range of 4.6-5.4 CPS (centipoise).

Polyvinyl alcohol 1799 refers to a polyvinyl alcohol product with a degree of polymerization of around 1,700 and a degree of alcoholysis of around 99%.

Polyvinyl alcohol 0588 refers to a polyvinyl alcohol product with a degree of polymerization of around 500 and a degree of alcoholysis of around 88%.

Polyvinyl alcohol 0599 refers to a polyvinyl alcohol product with a degree of polymerization of around 500 and a degree of alcoholysis of around 99%.

Polyvinyl alcohol 1750±50 refers to a polyvinyl alcohol product with a degree of polymerization of 1,700-1,800 and a degree of alcoholysis of around 88%.

Polyvinyl alcohol 124 refers to a polyvinyl alcohol product with an average degree of polymerization of 2,400-2,500, a degree of alcoholysis of 98%-99%, and a viscosity range of 54-65 cps.

In one embodiment of the present disclosure, the highly hygroscopic monomer in step (2) includes one or more selected from acrylic acid, acrylic acid salts, acrylamide, acrylic acid-acrylamide copolymers, N-isopropylacrylamide, 2-acrylamide-2-methylpropanesulfonic acid, acrylic acid-2-acrylamido-2-methylpropanesulfonic acid copolymers, sodium p-styrenesulfonate, lignin, chitosan, cellulose, carboxymethyl cellulose, sodium alginate, and quaternary ammonium guar gum.

In one embodiment of the present disclosure, the highly hygroscopic monomer in step (2) is 2-acrylamide-2-methylpropanesulfonic acid, or a combination of 2-acrylamide-2-methylpropanesulfonic acid with one or more additional monomers selected from acrylic acid, N-isopropylacrylamide, sodium p-styrenesulfonate, lignin, chitosan, cellulose, carboxymethyl cellulose, sodium alginate, and quaternary ammonium guar gum.

In one embodiment of the present disclosure, the crosslinking agent in step (2) includes one or more selected from N,N′-methylenebisacrylamide, glutaraldehyde, citric acid, and ethylene glycol diacrylate.

In one embodiment of the present disclosure, the initiator in step (2) includes one or more selected from azobisisobutyronitrile, ammonium persulfate, potassium persulfate, epichlorohydrin, and boric acid.

In one embodiment of the present disclosure, in step (2), the mass ratio of the PVA to the highly hygroscopic monomer in the hydrogel prepolymer solution is (0.4-0.8):1, with a further preferred ratio of 0.6:1.

In one embodiment of the present disclosure, in step (2), the PVA is present in the hydrogel prepolymer solution in an amount of 10-20% by mass.

In one embodiment of the present disclosure, in step (2), the highly hygroscopic monomer is present in the hydrogel prepolymer solution in an amount of 0-50% by mass, preferably 0-50% and not 0.

In one embodiment of the present disclosure, in step (2), the crosslinking agent is present in the hydrogel prepolymer solution in an amount of 0.1-1.0% by mass.

In one embodiment of the present disclosure, in step (2), the initiator is present in the hydrogel prepolymer solution in an amount of 0.1-1.0% by mass.

In one embodiment of the present disclosure, in step (2), PVA is first dissolved in water to prepare a PVA solution, which is then mixed with the highly hygroscopic monomer, the crosslinking agent, the initiator, and water, and stirred uniformly to obtain the hydrogel prepolymer solution.

In one embodiment of the present disclosure, the PVA solution in step (2) is obtained by dissolving PVA in water, where, the PVA is present in the PVA solution in an amount of 5-50% by mass.

A second objective of the present disclosure is to provide a leaf-inspired hydrogel composite prepared by the aforementioned method.

### Beneficial Effects

The leaf-inspired hydrogel composite prepared by the present disclosure can simulate the “water absorption valleys” of plant leaves, and the spectral correlation coefficient with real Camellia japonica leaves is as high as 0.98 or above. The biomimetic composite prepared by the present disclosure omits the use of hygroscopic salts and simulates the transpiration of plant leaves solely through highly hydrophilic hydrogels. This approach avoids the issues of unstable water absorption of materials, degraded simulation performance, and poor durability associated with the easy leakage of hygroscopic salts. Additionally, the hydrogel exhibits robust adhesion to the fabric substrate through strong hydrogen bonding, ensuring excellent bonding strength with the internal fabric. The biomimetic composite prepared by the present disclosure has a simple structure and an easy preparation process, which has industrialization advantages.

The leaf-inspired hydrogel composite prepared by the present disclosure utilizes fabric materials as a framework, and bio-material PVA and hygroscopic monomers as a hydrogel matrix, thereby exhibiting excellent biocompatibility and degradability.

### BRIEF DESCRIPTION OF FIGURES

FIG. 1 is a schematic structural diagram of the leaf-inspired hydrogel composite of the present disclosure.

FIG. 2 is a schematic comparative diagram of spectral curves of leaf-inspired hydrogel composites prepared in Example 1 and Comparative Example 1 of the present disclosure and Camellia japonica leaves.

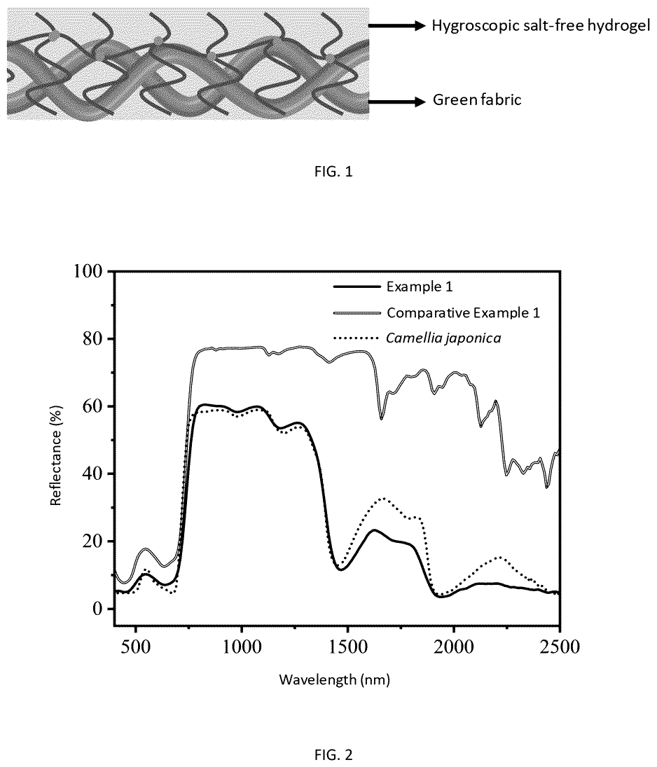

### DETAILED DESCRIPTION

The following examples further illustrate the outstanding advantages and significant features of the present disclosure, but the present disclosure is not limited to these examples.

The plant leaves involved in “leaf-inspired” in the present disclosure encompass, but are not limited to, flowers, Schefflera heptaphylla, Hypericum monogynum, Prunus serrulata, Zelkova serrata, Pterocarya stenoptera, Rohdea japonica, Ginkgo biloba, Prunus persica, Camellia japonica, Magnolia denudata, and Cinnamomum camphora leaves.

The present disclosure relates to the following testing methods:

### (1) Reflectance Spectrum Curve

A sample is placed in a solid reflectance sample chamber of a Lambda 950 UV/Vis/NIR spectrophotometer to test a reflectance spectrum curve of the sample in the range of 4,000-1,200 nm, with a wavelength interval of 10 nm.

### (2) Spectral Correlation Coefficient (γ)

The spectral correlation coefficient (γ) between the sample and green plant leaves is calculated according to Formula 1.

$$γ = \frac{{\sum }_{i = 1}^{n} ( {p}_{i} - \overline{p} ) ( {q}_{i} - \overline{q} )}{\sqrt{{\sum }_{i = 1}^{n} {( {p}_{i} - \overline{p} )}^{2}} \sqrt{{\sum }_{i = 1}^{n} {( {q}_{i} - \overline{q} )}^{2}}} \qquad ( Formula 1 )$$

where, pᵢ is a spectral vector of the sample; qᵢ is a reference standard spectral vector; p̅ and q̅ are average spectra.

(3) The position and reflectance range of the “water absorption valleys” of plant leaves

The leaves of various plants in Wuxi area, such as Camellia japonica, Cinnamomum camphora, Photinia serratifolia, Osmanthus fragrans, and Magnolia denudata, are cleaned and are tested for the visible light-near infrared reflectance spectrum respectively. The test results show that there are two “water absorption valleys” in the leaves of plants, which are located at 1,450 nm and 1,930 nm respectively, and the corresponding reflectance ranges are 10-30% and 4-10% respectively.

### Example 1

A method for preparing a leaf-inspired hydrogel composite included the following steps:

### (1) Preparation of Green Fabric:

A colorant, printing auxiliaries, and water were uniformly mixed and stirred to form a paste, thereby obtaining a green printing paste. The mass fractions of each component in the printing paste were as follows: disperse blue NP-SBG 0.6%, disperse deep blue HGL 0.28%, disperse orange 30 0.5%, dispersant 85A 1.38%, thickener DM-5221G 6%, with the remainder being water. The total mass fraction of the above components was 100%. The printing paste was applied onto the surface of polyester fabric by flat screen printing. Pre-baking was conducted at 80° C. for 5 minutes, baking was conducted at 180° C. for 2 minutes, reduction clearing was conducted at 80° C. for 10 minutes, and then drying was conducted at 80° C. after washing to obtain the green fabric.

### (2) Preparation of Hydrogel Prepolymer Solution:

20 g of low-viscosity PVA 1788 was dissolved in 80 g of water. The mixture was stirred at 90° C. for complete dissolution, and cooled to room temperature to obtain a PVA solution with a mass fraction of 20%. The PVA solution, a hygroscopic monomer (2-acrylamide-2-methylpropanesulfonic acid), a crosslinking agent (N,N′-methylenebisacrylamide), an initiator (ammonium persulfate), and water were mixed and stirred uniformly. Purging with nitrogen was conducted for 20 minutes to prepare the hydrogel prepolymer solution. The mass fractions of each component in the prepolymer solution were as follows: PVA solution 60%, 2-acrylamide-2-methylpropanesulfonic acid 20% (the mass ratio of PVA to 2-acrylamide-2-methylpropanesulfonic acid was 0.6:1), N,N′-methylenebisacrylamide 0.7%, ammonium persulfate 0.6%, with the remainder being water. The total mass fraction of the above components was 100%.

### (3) Preparation of Leaf-Inspired Hydrogel Composite:

The green fabric obtained in step (1) was cut to a size of 10 cm×10 cm and laid flat in a mold. 15 mL of the hydrogel prepolymer solution obtained in step (2) was added. Polymerizing was conducted at 60° C. for 12 hours to obtain the leaf-inspired hydrogel composite.

The resulting biomimetic composite was stood under conditions of 25° C. and 60% RH for 24 hours to reach hygroscopic equilibrium. Spectral testing was conducted on it, its spectral curve in comparison with that of Camellia japonica leaves was plotted (FIG. 2), the spectral correlation coefficient between the two was calculated according to Formula 1, and the reflectance at the two “water absorption valleys” was recorded (Table 1).

As shown in FIG. 2, the spectral curve of the prepared biomimetic composite is similar to that of the Camellia japonica leaves, with a spectral correlation coefficient of 0.984.

### Example 2

A method for preparing a leaf-inspired hydrogel composite included the following steps:

### (1) Preparation of Green Fabric:

A colorant, printing auxiliaries, and water were uniformly mixed and stirred to form a paste, thereby obtaining a green printing paste. The mass fractions of each component in the printing paste were as follows: disperse blue NP-SBG 0.6%, disperse deep blue HGL 0.28%, disperse orange 30 0.5%, dispersant 85A 1.38%, thickener DM-5221G 6%, adhesive DM 5128A 30%, with the remainder being water. The total mass fraction of the above components was 100%. The printing paste was applied onto the surface of cotton fabric by flat screen printing. Pre-baking was conducted at 80° C. for 5 minutes, and baking was conducted at 180° C. for 2 minutes to obtain the green fabric.

### (2) Preparation of Hydrogel Prepolymer Solution:

Same as step (2) in Example 1.

### (3) Preparation of Leaf-Inspired Hydrogel Composite:

Same as step (3) in Example 1.

The resulting biomimetic composite was stood under conditions of 25° C. and 60% RH for 24 hours to reach hygroscopic equilibrium. Spectral testing was conducted on the biomimetic composite, and the spectral correlation coefficient between the biomimetic composite and Camellia japonica leaves was calculated according to Formula 1.

The spectral correlation coefficient of the biomimetic composite and the Camellia japonica leaves was 0.981 after testing and calculation.

### Example 3

A method for preparing a leaf-inspired hydrogel composite included the following steps:

### (1) Preparation of Green Fabric:

A colorant, printing auxiliaries, and water were uniformly mixed and stirred to form a paste, thereby obtaining a green printing paste. The mass fractions of each component in the printing paste were as follows: chromium oxide 3%, dispersant 85A 2%, thickener DM-5221G 6%, adhesive DM 5128A 30%, with the remainder being water. The total mass fraction of the above components was 100%. The printing paste was applied onto the surface of polyester fabric by flat screen printing. Drying was conducted at 80° C. to obtain the green fabric.

### (2) Preparation of Hydrogel Prepolymer Solution:

Same as step (2) in Example 1.

### (3) Preparation of Leaf-Inspired Hydrogel Composite:

Same as step (3) in Example 1.

The resulting biomimetic composite was stood under conditions of 25° C. and 60% RH for 24 hours to reach hygroscopic equilibrium. Spectral testing was conducted on the biomimetic composite, and the spectral correlation coefficient between the biomimetic composite and Camellia japonica leaves was calculated according to Formula 1.

The spectral correlation coefficient of the biomimetic composite and the Camellia japonica leaves was 0.977 after testing and calculation.

### Example 4

The biomimetic composite was prepared as in Example 1, dried at 60° C., and then stood under conditions of 25° C. and 30%, 60%, and 90% RH for 24 hours to reach hygroscopic equilibrium, respectively.

Spectral testing was conducted on the biomimetic composite that has reached hygroscopic equilibrium under different humidity conditions and the reflectance at the two “water absorption valleys” was recorded (Table 1).

TABLE 1
Reflectance at the “Water Absorption Valleys” of the Biomimetic
Composite in Example 4 under Different Humidity Conditions

| | Reflectance at 1,450 nm | Reflectance at 1,930 nm |
|---|---|---|
| Humidity | (%) | (%) |
| 30% RH | 25.43 | 8.85 |
| 60% RH | 17.51 | 5.95 |
| 90% RH | 12.87 | 4.77 |

As shown in Table 1, the leaf-inspired hydrogel composite prepared in Example 1 of the present disclosure can meet the spectral feature requirements of the “water absorption valleys” of plant leaves under different humidity conditions, showing good simulation performances. Moreover, as the humidity increases, the reflectance of the biomimetic material at the “water absorption valleys” gradually decreases, indicating that the composite can regulate its water absorption according to the humidity changes and has good environmental adaptability.

### Example 5

The biomimetic composite was prepared as in Example 1, and cut to a size of 6 cm×6 cm. The cut biomimetic composite was immersed in 250 ml of water for 6 hours. Then, the biomimetic composite was taken out, dried at 60° C., and stood under conditions of 25° C. and 60% RH for 24 hours to reach hygroscopic equilibrium.

Spectral testing was conducted on the biomimetic composite before and after immersion in water, and the reflectance at the two “water absorption valleys” was recorded (Table 2).

### Comparative Example 1

A method for preparing a leaf-inspired hydrogel composite included the following steps:

### (1) Preparation of Green Fabric:

Same as step (1) in Example 1.

### (2) Preparation of Hydrogel Prepolymer Solution:

20 g of low-viscosity PVA 1788 was dissolved in 80 g of water. The mixture was stirred at 90° C. for complete dissolution, and cooled to room temperature to obtain a PVA solution with a mass fraction of 20%. The PVA solution, a crosslinking agent (N,N′-methylenebisacrylamide), an initiator (ammonium persulfate), and water were mixed and stirred uniformly. Purging with nitrogen was conducted for 20 minutes to prepare the hydrogel prepolymer solution. The mass fractions of each component in the prepolymer solution were as follows: PVA solution 80%, N,N′-methylenebisacrylamide 0.7%, ammonium persulfate 0.6%, with the remainder being water. The total mass fraction of the above components was 100%.

### (3) Preparation of Leaf-Inspired Hydrogel Composite:

Same as step (3) in Example 1.

The resulting biomimetic composite was stood under conditions of 25° C. and 60% RH for 24 hours to reach hygroscopic equilibrium. Spectral testing was conducted on the biomimetic composite, its spectral curve in comparison with that of Camellia japonica leaves was plotted (FIG. 2), and the spectral correlation coefficient between the two was calculated according to Formula 1.

As shown in FIG. 2, the prepared biomimetic composite exhibits low spectral curve similarity to the Camellia japonica leaves, with a spectral correlation coefficient of 0.640. Notably, it lacks the spectral features of the “water absorption valleys.” Compared with Example 1, it can be seen that the hygroscopic monomer in the hydrogel has an important influence on the simulation performance of the “water absorption valleys” of the biomimetic composite.

### Comparative Example 2

Preparation of a biomimetic material using hygroscopic metal salts according to patent CN114214847A includes the following steps:

### (1) Preparation of Green Fabric:

Same as step (1) in Example 1.

### (2) Preparation of Hydrogel Prepolymer Solution:

1.0 g of sodium alginate powder was added to 100 ml of water with continuous stirring until complete dissolution to form a sodium alginate aqueous solution. 10 g of calcium chloride was uniformly mixed with 90 g of water to prepare a calcium chloride solution with a mass fraction of 10%.

### (3) Preparation of Biomimetic Material:

The green fabric obtained in step (1) was cut to an appropriate size and placed in a mold. The sodium alginate aqueous solution obtained in step (2) was added to achieve a 3 mm thickness. The calcium chloride solution obtained in step (2) was sprayed to attain a total thickness of 6 mm. The composite was stood at ambient temperature for 30 minutes, followed by drying at 50° C. for 24 hours to obtain the biomimetic material.

The biomimetic composite obtained in step (3) was cut to a size of 6 cm×6 cm. The cut biomimetic composite was immersed in 250 ml of water for 6 hours. Then, the biomimetic composite was taken out, dried at 60° C., and stood under conditions of 25° C. and 60% RH for 24 hours to reach hygroscopic equilibrium.

Spectral testing was conducted on the biomimetic material before and after immersion in water, and the reflectance at the two “water absorption valleys” was recorded (Table 2).

TABLE 2
Reflectance at the “Water Absorption Valleys”
of the Biomimetic Material Prepared in Example 5 and
Comparative Example 2 Before and After Immersion in Water

| | Reflectance at | Reflectance at |
|---|---|---|
| Sample | 1,450 nm (%) | 1,930 nm (%) |
| Example 5 before | 19.84 | 6.22 |
| immersion in water | | |
| Example 5 after | 20.88 | 6.73 |
| immersion in water | | |
| Comparative example 2 | 15.37 | 6.01 |
| before immersion in water | | |
| Comparative example 2 | 27.44 | 11.85 |
| after immersion in water | | |

As shown in Table 2, the biomimetic composite prepared in Example 5 of the present disclosure exhibits minimal variation in reflectance before and after water immersion, demonstrating stable water absorption, superior simulation performance, and enhanced durability. In contrast, the biomimetic material of Comparative Example 2 prepared with hygroscopic metal salts exhibits a significant increase in reflectance after water immersion. The reflectance at 1,450 nm approaches the upper limit of the “water absorption valleys” of plant leaves, while the reflectance at 1,930 nm exceeds the acceptable range for plant leaf simulation. This indicates substantial leaching of calcium chloride hygroscopic salts in the material, leading to degradation of simulation performance.

### Comparative Example 3

### (1) Preparation of Green Fabric:

Same as step (1) in Example 1.

### (2) Preparation of Hydrogel Prepolymer Solution:

20 g of low-viscosity PVA 1788 was dissolved in 80 g of water. The mixture was stirred at 90° C. for complete dissolution, and cooled to room temperature to obtain a PVA solution with a mass fraction of 20%. The PVA solution, a hygroscopic monomer, a crosslinking agent, an initiator, and water were mixed and stirred uniformly. Purging with nitrogen was conducted for 20 minutes to prepare the hydrogel prepolymer solution. The mass fractions of each component in the prepolymer solution were as follows: PVA solution 40%, 2-acrylamide-2-methylpropanesulfonic acid 40% (the mass ratio of PVA to 2-acrylamide-2-methylpropanesulfonic acid was 0.2:1), N,N′-methylenebisacrylamide 0.7%, ammonium persulfate 0.6%, with the remainder being water. The total mass fraction of the above components was 100%.

### (3) Preparation of Leaf-Inspired Hydrogel Composite:

Same as step (3) in Example 1.

The resulting biomimetic composite was stood under conditions of 25° C. and 60% RH for 24 hours to reach hygroscopic equilibrium. Spectral testing was conducted on the biomimetic composite, the spectral correlation coefficient between the biomimetic composite and Camellia japonica leaves was calculated according to Formula 1, and the reflectance at the two “water absorption valleys” was recorded.

After testing and calculation, the spectral correlation coefficient between the material and the Camellia japonica leaves was 0.713, and the reflectance of its spectral curve at 1,450 nm and 1,930 nm was 3.29% and 2.94%, respectively. Compared with Example 1, when a higher amount of 2-acrylamide-2-methylpropanesulfonic acid was used, the increased hygroscopicity of the biomimetic material results in excessively low reflectance of its reflection curve at 1,450 nm and 1,930 nm to be too low, thus failing to meet the spectral requirements of the “water absorption valleys” of plant leaves.

### Comparative Example 4

### (1) Preparation of Green Fabric:

Same as step (1) in Example 1.

### (2) Preparation of Hydrogel Prepolymer Solution:

20 g of low-viscosity PVA 1788 was dissolved in 80 g of water. The mixture was stirred at 90° C. for complete dissolution, and cooled to room temperature to obtain a PVA solution with a mass fraction of 20%. The PVA solution, a hygroscopic monomer, a crosslinking agent, an initiator, and water was mixed and stirred uniformly. Purging with nitrogen was conducted for 20 minutes to prepare the hydrogel prepolymer solution. The mass fractions of each component in the prepolymer solution were as follows: PVA solution 70%, 2-acrylamide-2-methylpropanesulfonic acid 10% (the mass ratio of PVA to 2-acrylamide-2-methylpropanesulfonic acid was 1.4:1), N,N′-methylenebisacrylamide 0.7%, ammonium persulfate 0.6%, with the remainder being water. The total mass fraction of the above components was 100%.

### (3) Preparation of Leaf-Inspired Hydrogel Composite:

Same as step (3) in Example 1.

The resulting biomimetic composite was stood under conditions of 25° C. and 60% RH for 24 hours to reach hygroscopic equilibrium. Spectral testing was conducted on the biomimetic composite, the spectral correlation coefficient between the biomimetic composite and Camellia japonica leaves was calculated according to Formula 1, and the reflectance at the two “water absorption valleys” was recorded.

After testing and calculation, the spectral correlation coefficient between the material and Camellia japonica leaves was 0.811, and the reflectance of its spectral curve at 1,450 nm and 1,930 nm was 43.39% and 14.33%, respectively. Compared with Comparative Example 1, the addition of 2-acrylamide-2-methylpropanesulfonic acid endowed the biomimetic material with certain hygroscopicity, and its spectral curve exhibited two “water absorption valleys”. Compared with Example 1, the lower amount of added 2-acrylamide-2-methylpropanesulfonic acid resulted in higher reflectance of the reflectance curve of the biomimetic material at 1,450 nm and 1,930 nm, thus failing to meet the spectral requirements of the “water absorption valleys” of plant leaves.

### Comparative Example 5

### (1) Preparation of Green Fabric:

Same as step (1) in Example 1.

### (2) Preparation of Hydrogel Prepolymer Solution:

20 g of low-viscosity PVA 1788 was dissolved in 80 g of water. The mixture was stirred at 90° C. for complete dissolution, and cooled to room temperature to obtain a PVA solution with a mass fraction of 20%. The PVA solution, a hygroscopic monomer (acrylamide), a crosslinking agent (N,N′-methylenebisacrylamide), an initiator (ammonium persulfate), and water was mixed and stirred uniformly. Purging with nitrogen was conducted for 20 minutes to prepare the hydrogel prepolymer solution. The mass fractions of each component in the prepolymer solution were as follows: PVA solution 60%, acrylamide 20%, N,N′-methylenebisacrylamide 0.7%, ammonium persulfate 0.6%, with the remainder being water. The total mass fraction of the above components was 100%.

### (3) Preparation of Leaf-Inspired Hydrogel Composite:

Same as step (3) in Example 1.

The resulting biomimetic composite was stood under conditions of 25° C. and 60% RH for 24 hours to reach hygroscopic equilibrium. Spectral testing was conducted on the biomimetic composite, the spectral correlation coefficient between the biomimetic composite and Camellia japonica leaves was calculated according to Formula 1, and the reflectance at the two “water absorption valleys” was recorded.

After testing and calculation, the spectral correlation coefficient between the material and Camellia japonica leaves was 0.827, and the reflectance of its spectral curve at 1,450 nm and 1,930 nm was 25.46% and 12.08%, respectively. Compared with Example 1, the spectral correlation coefficient between the material and Camellia japonica leaves decreased, and the reflectance at 1,930 nm exceeded the spectral requirements of the “water absorption valleys” of plant leaves.

### Comparative Example 6

### (1) Preparation of Green Fabric:

Same as step (1) in Example 1.

### (2) Preparation of Hydrogel Prepolymer Solution:

20 g of acrylic acid was added in 80 g of water. The mixture was stirred to obtain an acrylic acid solution with a mass fraction of 20%. The acrylic acid solution, a hygroscopic monomer, a crosslinking agent, an initiator, and water was mixed and stirred uniformly. Purging with nitrogen was conducted for 20 minutes to prepare the hydrogel prepolymer solution. The mass fractions of each component in the prepolymer solution were as follows: acrylic acid solution 60%, 2-acrylamide-2-methylpropanesulfonic acid 20%, N,N′-methylenebisacrylamide 0.7%, ammonium persulfate 0.6%, with the remainder being water. The total mass fraction of the above components was 100%.

### (3) Preparation of Leaf-Inspired Hydrogel Composite:

Same as step (3) in Example 1.

The resulting biomimetic composite was stood under conditions of 25° C. and 60% RH for 24 hours to reach hygroscopic equilibrium. Spectral testing was conducted on the biomimetic composite, the spectral correlation coefficient between the biomimetic composite and Camellia japonica leaves was calculated according to Formula 1, and the reflectance at the two “water absorption valleys” was recorded.

After testing and calculation, the spectral correlation coefficient between the material and Camellia japonica leaves was 0.755, and the reflectance of its spectral curve at 1,450 nm and 1,930 nm was 8.11% and 3.02%, respectively. Compared with Example 1, the spectral correlation coefficient between the material and Camellia japonica leaves decreased, and the reflectance at 1,450 nm and 1,930 nm was too low to meet the spectral requirements of the “water absorption valleys” of plant leaves.

Although disclosed with preferred examples above, the present disclosure is not limited by the examples. Any person skilled in the art may make various alternations and modifications without departing the spirit and scope of the present disclosure. Therefore, the scope of protection of the present disclosure should be subject to the scope as defined in the claims.

What is claimed is:

1. A method for preparing a leaf-inspired hydrogel composite, comprising the following steps:
(1) preparation of green fabric:
uniformly mixing a colorant, printing auxiliaries, and water to form a paste-like green printing paste; subsequently applying the printing paste onto a fabric surface via screen printing to obtain a green fabric;
(2) preparation of hydrogel prepolymer solution:
mixing PVA, a highly hygroscopic monomer, a crosslinking agent, an initiator, and water and stirring uniformly to obtain a hydrogel prepolymer solution; and
(3) preparation of leaf-inspired hydrogel composite:
combining the green fabric obtained in step (1) with the hydrogel prepolymer solution obtained in step (2), followed by thermal polymerization to yield the leaf-inspired hydrogel composite.

2. The method according to claim 1, wherein the colorant in step (1) comprises one or more selected from chromium oxide, a disperse dye, a vat dye, an acid dye, a reactive dye, dry leaf powder, and sodium copper chlorophyllin.

3. The method according to claim 1, wherein the printing auxiliaries in step (1) comprise one or more selected from a dispersant, a thickener, and an adhesive.

4. The method according to claim 1, wherein the fabric in step (1) comprises one or more selected from a polyester fabric, a polyester-cotton blended fabric, a cotton fabric, a viscose fabric, and a chinlon fabric.

5. The method according to claim 1, wherein the green printing paste in step (1) is prepared by uniformly mixing and stirring the colorant, the printing auxiliaries and water into a paste, wherein, the colorant is present in an amount of 0.1-5.0 wt % in the green printing paste, and the printing auxiliaries are present in an amount of 5.0-40.0 wt % in the green printing paste.

6. The method according to claim 1, wherein the highly hygroscopic monomer in step (2) is 2-acrylamide-2-methylpropanesulfonic acid, or a combination of 2-acrylamide-2-methylpropanesulfonic acid with one or more additional monomers selected from acrylic acid, N-isopropylacrylamide, sodium p-styrenesulfonate, lignin, chitosan, cellulose, carboxymethyl cellulose, sodium alginate, and quaternary ammonium guar gum.

7. The method according to claim 1, wherein in step (2), the PVA is present in the hydrogel prepolymer solution in an amount of 10-20% by mass; and the highly hygroscopic monomer is present in an amount of 0-50% by mass.

8. The method according to claim 1, wherein in step (2), the mass ratio of the PVA to the highly hygroscopic monomer in the hydrogel prepolymer solution is (0.4-0.8):1.

9. The method according to claim 1, wherein in step (2), the crosslinking agent comprises one or more selected from N,N′-methylenebisacrylamide, glutaraldehyde, citric acid, and ethylene glycol diacrylate.

10. The method according to claim 1, wherein in step (2), the crosslinking agent is present in the hydrogel prepolymer solution in an amount of 0.1-1.0% by mass.

11. The method according to claim 1, wherein in step (2), the initiator comprises one or more selected from azobisisobutyronitrile, ammonium persulfate, potassium persulfate, epichlorohydrin, and boric acid.

12. The method according to claim 1, wherein in step (2), the initiator is present in the hydrogel prepolymer solution in an amount of 0.1-1.0% by mass.
